(19) United States
(12) Patent Application Publication
(10) Pub. No.: US 2015/0154206 A1
(43) Pub. Date: Jun. 4, 2015

(54) SECURE MANAGEMENT OF MESSAGE ARCHIVES

(71) Applicants: Cellco Partnership d/b/a Verizon Wireless, Arlington, VA (US); Verizon Patent and Licensing Inc., Arlington, VA (US)

(72) Inventors: Kumar Sanjeev, San Ramon, CA (US); Zhijian Lin, Dublin, CA (US); Ye Huang, San Ramon, CA (US); Eliezer K. Pasetes, Long Beach, CA (US)

(73) Assignees: Cellco Partnership d/b/a Verizon Wireless, Arlington, VA (US); Verizon Patent and Licensing Inc., Arlington, VA (US)

(21) Appl. No.: 14/095,936

(22) Filed: Dec. 3, 2013

(51) Int. Cl. G06F 17/30

(52) U.S. Cl. CPC G06F 17/30073

(57) ABSTRACT

A first server device may receive a group identifier, a first list including one or more first user device identifiers, and an instruction to archive messages associated with the one or more first user device identifiers; receive a second list including one or more second user device identifiers that are associated with the group identifier; and generate a third list including one or more third user device identifiers that are in the first list and the second list. The first server device may receive a message associated with a user device identifier; determine that the message is to be archived when the user device identifier associated with the message is included in the third list; and provide the message to a second server device based on the determination that the message is to be archived.

### BACKGROUND

User devices often transmit electronic messages between parties. The archiving of messages, associated with user devices owned and/or maintained by a particular group (e.g., a company, an organization, etc.), can be complex, and may infringe on privacy when the archiving of messages is not authorized by a user or a group associated with the messages.

### BRIEF DESCRIPTION OF THE DRAWINGS

FIG. 1 illustrates an example overview of an implementation described herein;

FIG. 2 illustrates an example environment in which systems and/or methods, described herein, may be implemented;

FIG. 3 illustrates a message flow diagram of example operations capable of being performed by an example portion of the environment of FIG. 2;

FIG. 4 illustrates a flowchart of an example process for processing a message archiving instruction;

FIG. 5 illustrates a flowchart of an example process for processing a forwarding activation/deactivation instruction associated with a message archiving instruction;

FIG. 6 illustrates an example data structure that may be stored by one or more devices in the environment of FIG. 2;

FIGS. 7A-7B and 8 illustrate example implementations as described herein; and

FIG. 9 illustrates example components of one or more devices, according to one or more implementations described herein.

### DETAILED DESCRIPTION OF THE PREFERRED EMBODIMENTS

The following detailed description refers to the accompanying drawings. The same reference numbers in different drawings may identify the same or similar elements.

Systems and/or methods, as described herein, may provide secure management of message archiving services to archive messages (e.g., short message service (SMS) messages, multimedia message service (MMS) messages, a packet-based message, etc.) received/sent by one or more user devices associated with a particular group (e.g., a client, enterprise, company, organization, or the like).

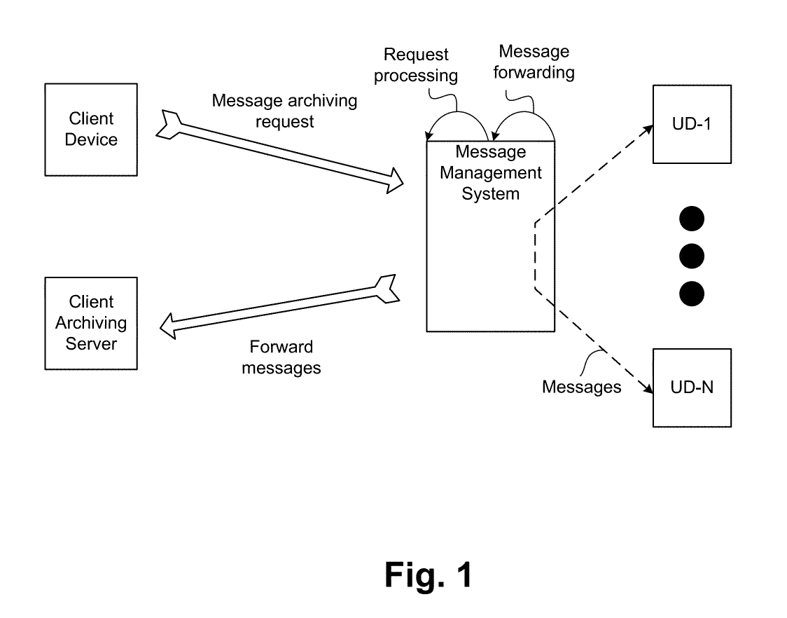

FIG. 1 illustrates an example overview of an implementation described herein. As shown in FIG. 1, a message management system may operate to control the archiving of messages received from user devices (UD-1 through UD-N). A client device may access a message management system to provide a message archiving request. In some implementations, the message archiving request may include a request to activate or deactivate (e.g., discontinue) message archiving services for one or more user devices associated with a particular group. In some implementations, the message archiving request may include an identifier (ID) of the group (e.g., a group ID), one or more IDs associated with the one or more user devices (e.g., user device IDs (UDIDs)). In some implementations, the message archiving request may further include an instruction indicating that the message management system should begin archiving messages, for the user devices associated with the particular group, to the client archiving server.

In some implementations, the message management system may receive the message archiving request and may process the message archiving request in order to activate or deactivate message archiving services and to provide messages to the client archiving server for storage. For example, the message management system may determine whether the message archiving request includes valid authorization credentials and whether the UDID(s) of the user device(s) are associated with the group ID.

As an example, assume that the message archiving request includes a group ID of “G123,” authorization credentials (e.g., a password, a key, biometrics information, etc.), an instruction to activate message archiving services for the user device having an UDID identifying a first user device (e.g., “UD-1”), an identifier or network address identifying the client archiving server, and/or authorization parameters to access the client archiving server. Further, assume that the message management system stores the same authorization credentials for the group ID of “G123” as the authorization credentials included in the message archiving request. Further, assume that the message management system stores information identifying that the UDID is associated with the group ID of “G123.” Given these assumptions, the message management system may activate the message archiving services for UD-1. For example, the message management system may update a forwarding table that identifies UD-1 as a device whose messages are to be archived.

In some implementations, UD-1 may send/receive messages to/from multiple other user devices (e.g., UD-2 through UD-N, where N≧2). The message management system may facilitate the transmission of messages between UD-1 and UD-2 through UD-N and may identify that messages sent to/from UD-1 are to be archived (e.g., since the message archiving service has been activated). For example, when a message is sent to/from UD-1, the message management system may identify that the UDID, associated with the message, is included in the forwarding table and may provide messages, sent to/from UD-1 to the client archiving server. As a result, message archiving services for user devices may be activated and/or deactivated based on determining that a message archiving request was received from an authorized party (e.g., when authorization credentials included in the message archiving request match authorization credentials stored by the message management system). Further, the message archiving services for user devices may be activated and/or deactivated for those user devices associated with a group ID included in the message archiving request.

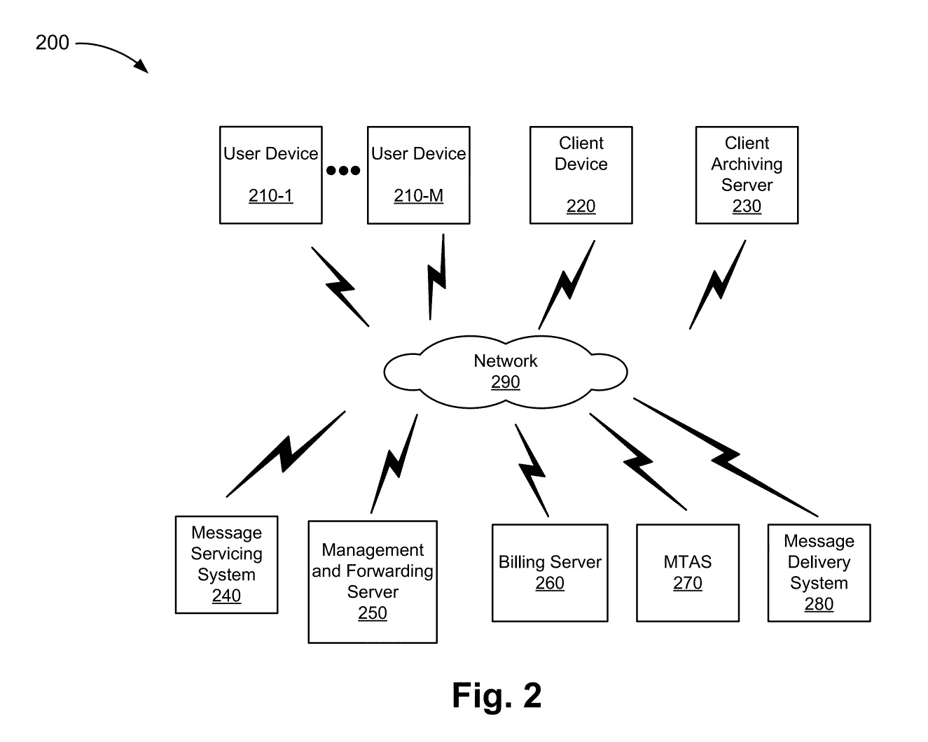

FIG. 2 is a diagram of an example environment 200 in which systems and/or methods described herein may be implemented. As shown in FIG. 2, environment 200 may include user devices 210-1, . . . , 210-M (where M≧1), client device 220, client archiving server 230, message servicing system 240, management and forwarding server 250, billing server 260, message transfer agent server (MTAS) 270, message delivery system 280, and network 290.

User device 210 may include a device capable of communicating via a network, such as network 290. For example, user device 210 may correspond to a mobile communication device (e.g., a smart phone or a personal digital assistant (PDA)), a portable computer device (e.g., a laptop or a tablet computer), a desktop computing device, a gaming device, a set-top box, or another type of device that may send/receive messages via message delivery system 280. In some implementations, user device 210 may send/receive messages, such as SMS messages, MMS, messages, IP packet-based messages, instant messages, e-mail messages, etc. The messages may include a header that identifies a UDID of user device 210.

Client device 220 may include a device capable of communicating via a network, such as network 290. For example, client device 220 may correspond to a mobile communication device (e.g., a smart phone or a PDA), a portable computer device (e.g., a laptop or a tablet computer), a desktop computing device, or another type of computing device. In some implementations, client device 220 may access message servicing system 240 to manage message services for one or more user devices 210 associated with a particular group ID. For example, client device 220 may access message archiving services to provide a message archiving instruction to modify archiving services for the one or more user devices 210. Additionally, or alternatively, client device 220 may access messaging services for the one or more user devices 210 (e.g., a service to simultaneously send messages to multiple user devices 210 associated with the group ID). Additionally, or alternatively, client device 220 may provide service modification instructions to modify services that the one or more user devices 210 may access (e.g., to modify a quantity of voice-call minutes that a particular user device 210 may access, cancel service for the particular user device 210, etc.). In some implementations, client device 220 may function as user device 210 and user device 210 may function as client device 220.

Client archiving server 230 may include one or more computing devices, such as a server device or a collection of server devices. In some implementations, client archiving server 230 may receive messages from management and forwarding server 250 that are to be archived (e.g., in accordance with message archiving services). Client archiving server 230 may store the messages for later retrieval by user device 210 and/or client device 220. In some implementations, client archiving server 230 may store a key that may be used to authenticate management and forwarding server 250 when receiving the messages.

Message servicing system 240 may include one or more computing devices, such as a server device or a collection of server devices. In some implementations, message servicing system 240 may provide messaging services for messaging subscribers. In some implementations, message servicing system 240 may be accessed via a web portal hosted by message servicing system 240, and may receive, from client device 220, service requests associated with a particular group ID. Message servicing system 240 may communicate with management and forwarding server 250 and/or billing server 260 to process the service requests (e.g., message archiving instructions to activate/deactivate archiving services, instructions add or remove particular services to/from user devices 210, etc.). For example, message servicing system 240 may communicate with management and forwarding server 250 to process a message archiving instruction (e.g., by providing management and forwarding server 250 with information regarding the message archiving instruction). Additionally, or alternatively, message servicing system 240 may communicate with billing server 260 to update billing information in accordance with services that are to be added or removed for user devices 210.

Management and forwarding server 250 may include one or more computing devices, such as a server device or a collection of server devices. In some implementations, management and forwarding server 250 may receive a message archiving instruction from message servicing system 240 or from client device 220 via web portal hosted by message servicing system 240. In some implementations, management and forwarding server 250 may process the message archiving instruction based on authorization credentials included in the message archiving instruction. Additionally, or alternatively, management and forwarding server 250 may communicate with billing server 260 to identify whether UDIDs included in the message archiving instruction are associated with the group ID included in the message archiving instruction (e.g., to authorize messages associated with the UDIDs to be archived). In some implementations, management and forwarding server 250 may maintain a message forwarding table that identifies messages that are to be forwarded based on a UDID, and information regarding a particular client archiving server 230 to forward the messages. Management and forwarding server 250 may receive a message from message delivery system 280 with header information identifying a UDID of the message, lookup the UDID in the forwarding table, and forward the message to the particular client archiving server 230 based on information stored by the forwarding table.

Billing server 260 may include one or more computing devices, such as a server device or a collection of server devices. In some implementations, billing server 260 may store a list of UDIDs associated with a particular group ID. In some implementations, billing server 260 may receive and process a request, received from management and forwarding server 250, for UDIDs associated with a group ID included in a message archiving instruction. Billing server 260 may maintain billing information for an account associated with a group and may update the billing information based on changes to services made on the account (e.g., changes in services made to user devices 210 associated with the group).

MTAS 270 may include one or more computing devices, such as a server device or a collection of server devices. In some implementations, MTAS 270 may include a message policy/protocol server and may receive (e.g., from management and forwarding server 250) a list of UDIDs and instructions to activate/deactivate archiving services for user devices 210 associated with the UDIDs. MTAS 270 may provide the list of UDIDs and instructions to activate/deactivate the archiving services to message delivery system 280.

Message delivery system 280 may include one or more computing devices, such as a server device or a collection of server devices. In some implementations, message delivery system 280 may correspond to a short message service center (SMSC) or some other type of network element to store, forward, convert, and/or deliver SMS, MMS, packet-based messages, and/or some other type of message to user device 210. In some implementations, message delivery system 280 may maintain a forwarding table to forward a copy of a message to management and forwarding server 250 based on the UDID of the message. Message delivery system 280 may add a UDID of user device 210 to the forwarding table based on receiving an instruction to activate an archiving service for user device 210. Message delivery system 280 may remove a UDID of user device 210 based on receiving an instruction to deactivate the archiving service for user device 210.

Network 290 may include one or more wired and/or wireless networks. For example, network 290 may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, network 290 may include a local area network (LAN), a wide area network (WAN), a metropolitan network (MAN), the Public Switched Telephone Network (PSTN), an ad hoc network, a managed Internet Protocol (IP network, a virtual private network (VPN), an intranet, the Internet, a fiber optic-based network, and/or a combination of these or other types of networks.

The quantity of devices and/or networks in environment is not limited to what is shown in FIG. 2. In practice, environment 200 may include additional devices and/or networks; fewer devices and/or networks; different devices and/or networks; or differently arranged devices and/or networks than illustrated in FIG. 2. Also, in some implementations, one or more of the devices of environment 200 may perform one or more functions described as being performed by another one or more of the devices of environment 200. Devices of environment 200 may interconnect via wired connections, wireless connections, or a combination of wired and wireless connections.

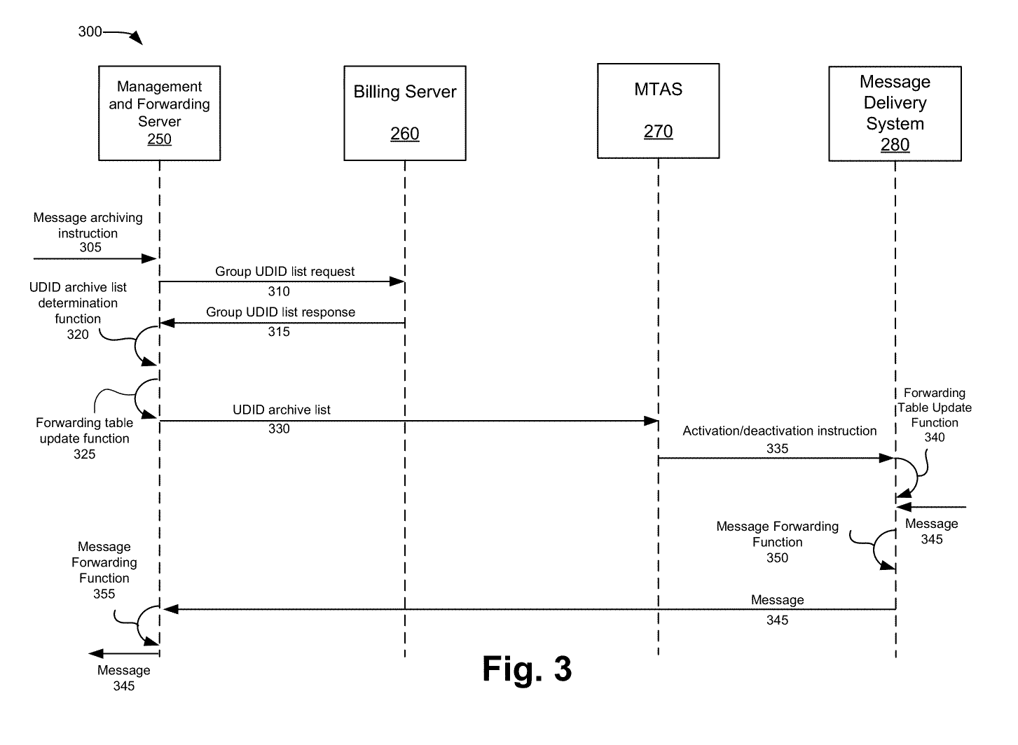

FIG. 3 illustrates a message flow diagram of example operations capable of being performed by an example portion 300 of environment 200. As shown in FIG. 3, portion 300 may include management and forwarding server 250, billing server 260, MTAS 270, and message delivery system 280 and may include components and/or perform functions described above in connection with, for example, one or more of FIGS. 1-2. FIG. 3 may correspond to example operations to process a message archiving instruction.

As shown in FIG. 3, management and forwarding server 250 may receive message archiving instruction 305. In some implementations, management and forwarding server 250 may receive message archiving instruction 305 from message servicing system 240 or from client device 220 via a web portal hosted by message servicing system 240. In some implementations, information included in message archiving instruction 305 may correspond to user inputs received by client device 220. In some implementations, message archiving instruction 305 may include a group ID, authorization information (e.g., a password, a key, biometrics information, etc.), a list of UDIDs, and instructions to activate and/or deactivate archiving services for user devices 210 associated with the UDIDs. In some implementations, message archiving instruction 305 may also identify types of messages that are to be archived (e.g., incoming SMS messages, outgoing SMS messages, incoming MMS messages, outgoing MMS messages, etc.). Additionally, or alternatively, message archiving instruction 305 may identify messages that are to be archived based on some other attribute of the messages (e.g., a telephone number, a message type, a mobile device number, an international mobile equipment identifier, and/or an integrated circuit card identifier of a sender and/or recipient of the messages, etc.).

In some implementations, management and forwarding server 250 may authorize message archiving instruction 305 based on the group ID and the authorization information. For example, management and forwarding server 250 may store authorization information based on the group ID and may authorize message archiving instruction 305 when the authorization information, included in message archiving instruction 305, matches authorization information stored by management and forwarding server 250.

Based on authorizing message archiving instruction 305, management and forwarding server 250 may provide group UDID list request 310 to billing server 260. In some implementations, UDID list request 310 may include the group ID included in message archiving instruction 305 and a request for a list of UDIDs associated with the group ID. In some implementations, UDID list request 310 may further include authorization information to permit management and forwarding server 250 to receive the list of UDIDs. Billing server 260 may receive UDID list request 310, authorize management and forwarding server 250 to receive the list of UDIDs (e.g., based on the authorization information included in UDID list request 310), identify the list of UDIDs based on the group ID, and provide group UDID list response 315 (e.g., a response including the list of UDIDs).

Management and forwarding server 250 may perform UDID archive list determination function 320 based on receiving group UDID list response 315. Management and forwarding server 250 may generate UDID archive list 330 including a group of UDIDs that are included in message archiving instruction 305 and also included in the UDID list of UDID list response 315. For example, assume that message archiving instruction 305 includes a list of five UDIDs (e.g., UDID 1, UDID 2, UDID 3, UDID 4, and UDID 5) and an instruction to activate message archiving services for user devices 210 corresponding to the list of the five UDIDs. Further, assume that group UDID list response 315 includes UDID 1, UDID 2, UDID 3, UDID 4, and UDID 6. Given these assumptions, UDID archive list 330 may include UDID 1, UDID 2, UDID 3, and UDID 4, but may not include UDID 5 (e.g., since UDID 5 is not associated with the group ID identified by message archiving instruction 305 indicating that messages, associated with UDID 5, may not be archived for the group associated with the group ID). In some implementations, UDID archive list 330 may also include instructions to activate and/or deactivate message archiving services for the UDIDs in accordance with message archiving instruction 350.

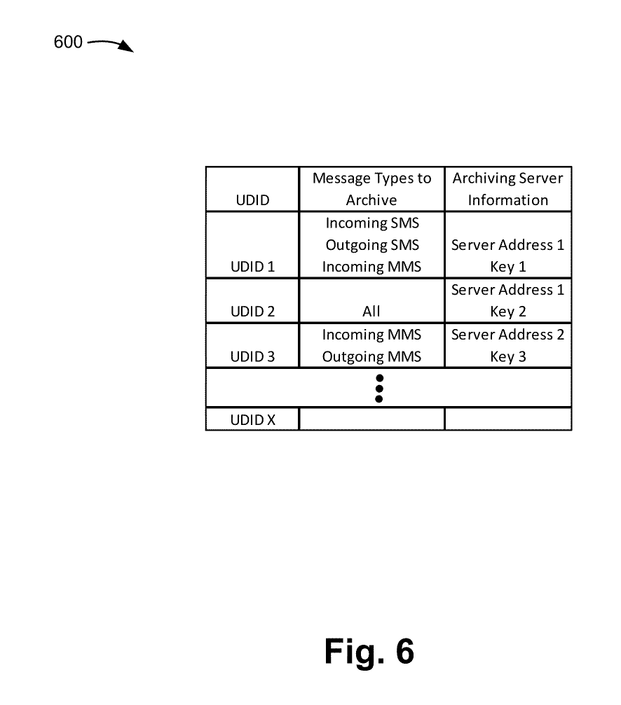

Management and forwarding server 250 may also perform forwarding table update function 325 to update a forwarding table that identifies messages that are to be forwarded to client archiving server 230 for storage. For example, based on an instruction to activate a message archiving service included in message archiving instruction 305, management and forwarding server 250 may add a UDID to the forwarding table, information identifying types of messages to forward, and information identifying a particular client archiving server 230 that is to receive the forwarded messages for storage. In some implementations, the forwarding table may include information identifying a particular client archiving server 230 that is to receive messages associated with a particular UDID, and authorization information used to communicate with the particular client archiving server 230 to provide the messages. An example of a message forwarding table is described below with respect to FIG. 6.

Management and forwarding server 250 may provide UDID archive list 330 to MTAS 270. Based on receiving UDID archive list 330, MTAS 270 may store policy information that identifies whether message archiving services are active or inactive based on UDID. In some implementations, MTAS 270 may generate and provide activation/deactivation instruction 335 to message delivery system 280. In some implementations, activation/deactivation instruction 335 may include information corresponding to UDID archive list 330, such as a list of UDIDs, and instructions to activate and/or deactivate archiving services associated with the UDIDs.

Message delivery system 280 may receive activation/deactivation instruction 335, and may perform forwarding table update function 340 based on receiving activation/deactivation instruction 335. For example, message delivery system 280 may update a forwarding table to reflect instructions included in activation/deactivation instruction 335. As an example, assume that activation/deactivation instruction 335 identifies that incoming and outgoing messages for UDID 1 are to be archived and that activation/deactivation instruction 335 identifies that incoming MMS messages are no longer to be archived for UDID 2. Given these assumptions, message delivery system 280 may update the forwarding table to reflect that incoming and outgoing messages for UDID 1 are to be archived and that incoming MMS messages are no longer to be archived for UDID 2.

Message delivery system 280 may receive message 345 (e.g., from user device 210-1 destined for user device 210-2). In some implementations, message 345 may include information identifying a UDID of user device 210-1, a UDID of user device 210-2, information identifying a type of message, and/or message content. In some implementations, message delivery system 280 may perform message forwarding function 350 based on receiving message 345. For example, message delivery system 280 may look up the UDID of user device 210-1 and the UDID of user device 210-2 in the forwarding table to determine whether message 345 is to be forwarded to management and forwarding server 250 for archiving (e.g., based on a UDID and/or a message type, such as an outgoing SMS message, an incoming MMS message, etc.). In FIG. 3, assume that the forwarding table indicates that outgoing messages, associated with the UDID of user device 210-1, are to be forwarded. Given this assumption, message delivery system 280 may provide message 345 to management and forwarding server 250 in addition to providing message 345 to user device 210-2.

Management and forwarding server 250 may receive message 345 and may perform message forwarding function 355 based on receiving message 345. In some implementations, management and forwarding server 250 may determine a particular client archiving server 230 to forward message 345 for storage by client archiving server 230. For example, management and forwarding server 250 may look up the UDIDs associated with message 345 (e.g., the UDIDs of user device 210-1 and user device 210-2) in a message forwarding table maintained by management and forwarding server 250 that identifies the particular client archiving server 230 is to be provided with message 345 based on UDID and/or the message type. In some implementations, the forwarding table may identify authorization information used to communicate with client archiving server 230 to provide message 345.

As an example, assume that message 345 includes information to identify a UDID of user device 210-1 and an “outgoing SMS” message typing. Further, assume that the forwarding table, maintained by management and forwarding server 250, identifies that outgoing SMS messages provided by the UDID of user device 210-1 are to be forwarded to a particular client archiving server 230. Further, assume that the forwarding table includes information that may be used to communicate with the particular client archiving server 230 to provide message 345. Given these assumption, management and forwarding server 250 may provide message 345 to the particular client archiving server 230. As a result, message archiving settings for particular UDIDs associated with a group ID may be securely updated, and messages associated with the UDIDs may be archived by a particular client archiving server 230 associated with the group ID. Further, only messages of UDIDs associated with the group ID may be archived.

While a particular series of operations and/or data flows have been described above with regards to FIG. 3, the order of the operations and/or data flows may be modified in other implementations. Further, non-dependent operations may be performed in parallel.

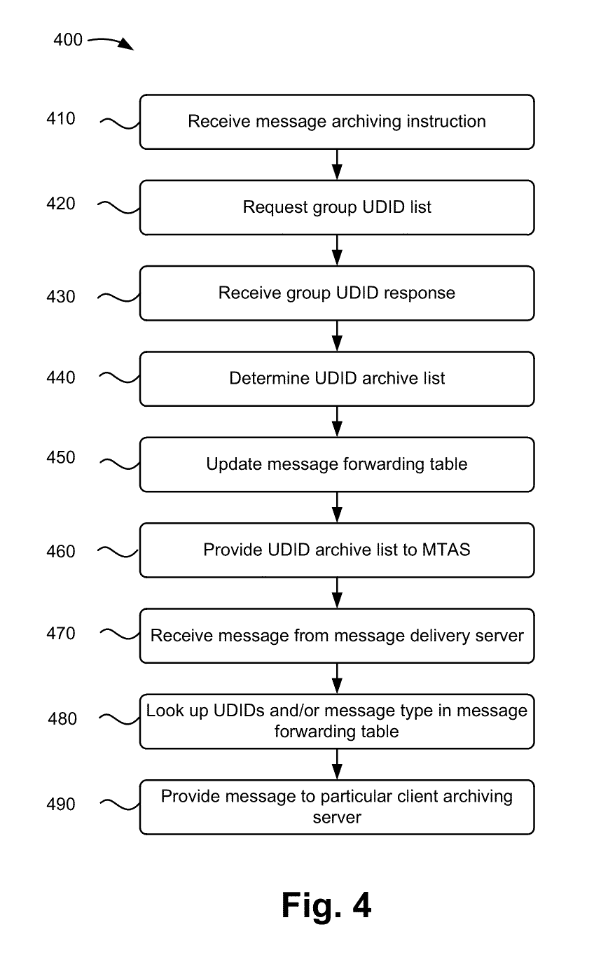

FIG. 4 illustrates a flowchart of an example process 400 for processing a message archiving instruction. In some implementations, process 400 may be performed by one or more components of management and forwarding server 250. In some implementations, some or all of process 400 may be performed by one or more components of another device in environment 200 (e.g., message servicing system 240, MTAS 270, and/or message delivery system 280), or a group of devices including or excluding management and forwarding server 250.

As shown in FIG. 4, process 400 may include receiving a message archiving instruction (block 410). For example, as described above with respect to message archiving instruction 305, management and forwarding server 250 may receive message archiving instruction 305 from message servicing system 240 or from client device 220 via a web portal hosted by message servicing system 240. In some implementations, message archiving instruction 305 may include a group ID, authorization information (e.g., a password, a key, biometrics information, etc.), a list of UDIDs, and instructions to activate and/or deactivate archiving services for user devices 210 associated with the UDIDs. In some implementations, message archiving instruction 305 may also identify types of messages that are to be archived (e.g., incoming SMS messages, outgoing SMS messages, incoming MMS messages, outgoing MMS messages, etc.). Additionally, or alternatively, message archiving instruction 305 may identify messages that are to be archived based on some other attribute of the messages (e.g., a telephone number, a message type, a mobile device number, an international mobile equipment identifier, and/or an integrated circuit card identifier of a sender and/or recipient of the messages, etc.). In some implementations, management and forwarding server 250 may authorize message archiving instruction 305 based on the group ID and the authorization information.

Process 400 may also include requesting a group UDID list (block 420). For example, as described above with respect to group UDID list request 310, management and forwarding server 250 may provide group UDID list request 310 based on receiving and authorizing the message archiving instruction. In some implementations, UDID list request 310 may include the group ID included in message archiving instruction 305 and a request for a list of UDIDs associated with the group ID. In some implementations, UDID list request 310 may further include authorization information to permit management and forwarding server 250 to receive the list of UDIDs.

Process 400 may further include receiving a group UDID response (block 430). For example, management and forwarding server 250 may receive group UDID response 315 from billing server 260. In some implementations, group UDID response 315 may include a list of UDIDs associated with the group ID in message archiving instruction 305.

Process 400 may also include determining a UDID archive list (block 440). For example, as described above with respect to UDID archive list determination function 320, management and forwarding server 250 may generate UDID archive list 330 including a group of UDIDs that are included in message archiving instruction 305 and also included in the UDID list of UDID list response 315 (e.g., a list of UDIDs that are associated with the group ID and whose archiving settings are permitted to be modified). In some implementations, management and forwarding server 250 may provide a response to client device 220 identifying UDIDs whose message archiving settings are not permitted to be modified when those UDIDs are not associated with the group ID provided as part of message archiving instruction 305.

Process 400 may further include updating a message forwarding table (block 450). For example, as described above with respect to forwarding table update function 325, management and forwarding server 250 may update the message forwarding table that identifies messages that are to be forwarded to client archiving server 230 for storage. In some implementations, management and forwarding server 250 may update the message forwarding table to reflect archiving activation/deactivation instructions included in message archiving instruction 305. In some implementations, the forwarding table may include information identifying a particular client archiving server 230 that is to receive messages associated with a particular UDID, and authorization information used to communicate with the particular client archiving server 230 to provide the messages. An example of a message forwarding table is described below with respect to FIG. 6.

Process 400 may also include providing the UDID archive list to an MTAS (block 460). For example, as described above, management and forwarding server 250 may provide UDID archive list 330 to MTAS 270. In some implementations, UDID archive list 330 may include instructions to activate and/or deactivate message archiving services for UDIDs included in the UDID archive list. In some implementations, MTAS 270 may direct message delivery system 280 to update a forwarding table, maintained by message delivery system 280, based on the instructions to activate and/or deactivate message archiving services for UDIDs included in the UDID archive list.

Process 400 may further include receiving a message from a message delivery server (block 470). For example, as described above, management and forwarding server 250 may receive the message from message delivery system 280 when message delivery system 280 receives the message destined from user device 210-1 to user device 210-2 and determines that a UDID of user device 210-1 and/or user device 210-2 is included in the forwarding table maintained by message delivery system 280.

Process 400 may also include looking up the UDIDs and/or the message type in the message forwarding table (block 480). For example, management and forwarding server 250 may look up the UDIDs associated with the message (e.g., the UDIDs of user device 210-1 and user device 210-2) and/or the message type in the message forwarding table maintained by management and forwarding server 250 that identifies a particular client archiving server 230 is to be provided with message 345 based on UDID and/or the message type. Additionally, or alternatively, management and forwarding server 250 may look up some other attribute associated with the message in the message forwarding table to identify the particular client archiving server 230 that is to be provided with message 345. For example, management and forwarding server 250 may look up a telephone number, a message type, a mobile device number, an international mobile equipment identifier, integrated circuit card identifier and/or some other attribute associated with the message. In FIG. 4, assume that the UDID of user device 210-1 or of user device 210-2, and the message type is included in the message forwarding table. Given this assumption, management and forwarding server 250 may identify the particular client archiving server 230 and authorization information used to communicate with client archiving server 230.

Process 400 may further include providing the message to the particular client archiving server (block 490). For example, management and forwarding server 250 may request to communicate with the particular client archiving server 230 based on a network address of the particular client archiving server 230 and/or authorization information associated with the particular client archiving server 230. In some implementations, management and forwarding server 250 may provide the message to the particular client archiving server 230 such that client archiving server 230 may store the message for future access. As a result, message archiving settings for particular UDIDs associated with a group ID may be securely updated, and messages associated with the UDIDs may be archived by a particular client archiving server 230 associated with the group ID. Further, only messages of UDIDs associated with the group ID may be archived.

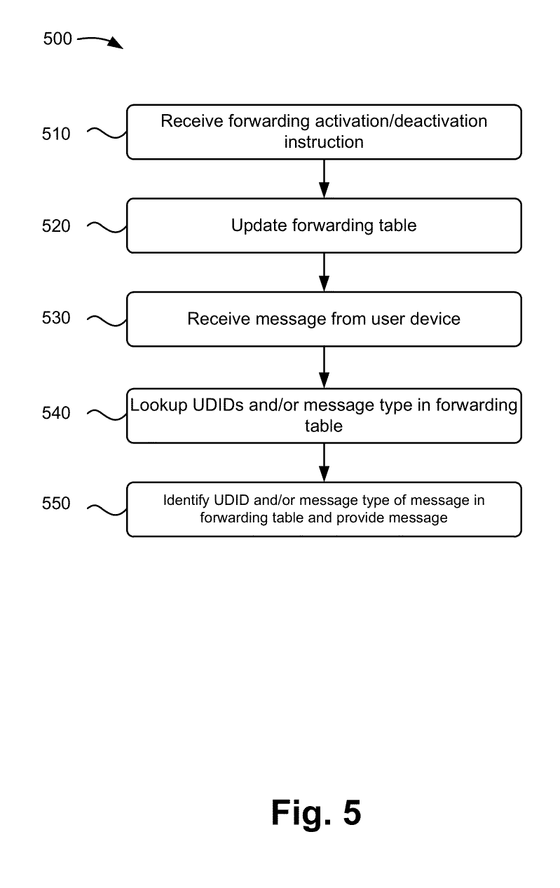

FIG. 5 illustrates a flowchart of an example process 500 for processing a forwarding activation/deactivation instruction associated with a message archiving instruction. In some implementations, process 500 may be performed by one or more components of message delivery system 280. In some implementations, some or all of blocks of process 500 may be performed by one or more components of another device in environment 200 (e.g., message servicing system 240, management and forwarding server 250, and/or MTAS 270), or a group of devices including or excluding message delivery system 280.

As shown in FIG. 5, process 500 may include receiving a forwarding activation/deactivation instruction (block 510). For example, as described above with respect to activation/deactivation instruction 335, message delivery system 280 may receive activation/deactivation instruction 335 from MTAS 270. In some implementations, activation/deactivation instruction 335 may include a list of UDIDs, and instructions to activate and/or deactivate archiving services associated with the UDIDs.

Process 500 may further include updating a forwarding table (block 520). For example, as described above with respect to forwarding table update function 340, message delivery system 280 may update a forwarding table, maintained by message delivery system 280, to reflect instructions included in activation/deactivation instruction 335. As an example, assume that activation/deactivation instruction 335 identifies that incoming and outgoing messages for UDID 1 are to be archived and that activation/deactivation instruction 335 identifies that incoming MMS messages are no longer to be archived for UDID 2. Given these assumptions, message delivery system 280 update the forwarding table to reflect that incoming and outgoing messages for UDID 1 are to be archived and that incoming MMS messages are no longer to be archived for UDID 2.

Process 500 may also include receiving messages from a user device (block 530). For example, message delivery system 280 may receive the message (e.g., from user device 210-1 destined for user device 210-2). In some implementations, the message may include information identifying a UDID of user device 210-1, a UDID of user device 210-2, information identifying a type of message, and/or message content.

Process 500 may further include looking up the UDIDs and/or the message type in the forwarding table (block 540). For example, as described above with respect to message forwarding function 350, message delivery system 280 may look up the UDID of user device 210-1 and the UDID of user device 210-2 in the forwarding table to determine whether message 345 is to be forwarded to management and forwarding server 250 for archiving (e.g., based on a UDID and/or a message type, such as an outgoing SMS message, an incoming MMS message, etc.). In some implementations, the forwarding table may store some other attribute of the message that may identify whether the message is to be provided to management and forwarding server 250.

Process 500 may also include identifying a UDID and/or message type of the message in the forwarding table and providing the message (block 550). For example, message delivery system 280 may identify that the UDID of user device 210-1 and/or user device 210-2 and/or the message type matches information stored by the forwarding table and provide the message to management and forwarding server 250. In some implementations, message delivery system 280 may identify some other attribute of the message and provide the message to the management and forwarding server based on matching attributes of the message with information stored by the forwarding table.

While FIGS. 4 and 5 show processes 400 and 500 as including a particular quantity and arrangement of blocks, in some implementations, processes 400 and 500 may include fewer blocks, additional blocks, or a different arrangement of blocks. Additionally, or alternatively, some of the blocks may be performed in parallel.

FIG. 6 illustrates an example data structure 600 that may be stored by one or more devices in environment 200, such as management and forwarding server 250 and/or message delivery system 280. In some implementations, data structure 600 may be stored in a memory of management and forwarding server 250 and/or message delivery system 280. In some implementations, data structure 600 may be stored in a memory separate from, but accessible by, management and forwarding server 250 and/or message delivery system 280 (e.g., a “cloud” storage device). In some implementations, data structure 600 may be stored by some other device in environment 200, such as client archiving server 230, message servicing system 240, billing server 260, and/or MTAS 270.

A particular instance of data structure 600 may contain different information and/or fields than another instance of data structure 600. In some implementations, data structure 600 may correspond to information included in a message forwarding table maintained by management and forwarding server 250. A portion of information stored by data structure 600 may correspond to information included in a forwarding table maintained by message delivery system 280. Information stored by data structure 600 may correspond to message archiving instructions provided by client device 220 (e.g., from a user of client device 220 via a user interface and/or a web portal having fields and/or selections to permit a user to input message archiving instructions).

In some implementations, each entry in data structure 600 may identify message archiving instructions for a particular UDID. For example, each entry may identify the UDID, message types that are to be archived, and information regarding a particular client archiving server 230 that is to receive messages (e.g., a network address of client archiving server 230 and/or authorization information to access client archiving server 230, such as a key, a password, etc.).

In the example shown in FIG. 6, data structure 600 may store information identifying “UDID 1” and message types associated with “UDID 1” that are to be archived, such as incoming SMS messages, outgoing SMS messages, and incoming MMS messages. Further, messages of these types and associated with “UDID 1” may be provided to the particular client archiving server 230 having the network address “Server Address 1” using authentication information (e.g., a key corresponding to “Key 1”).

In some implementations, data structure 600 may be stored by management and forwarding server 250 and a portion of data structure 600 may be stored by message delivery system 280. For example, message delivery system 280 may store information identifying that particular types of messages associated with particular UDIDs are to be forwarded to management and forwarding server 250. Once management and forwarding server 250 receives a message, management and forwarding server 250 may look up attributes of the message (e.g., UDIDs and/or types associated with the message) with information stored by data structure 600.

As described above, information stored by data structure 600 may correspond to message archiving instructions provided by client device 220. In some implementations, information stored by data structure 600 may be populated and/or updated when management and forwarding server 250 performs forwarding table update function 325 and/or when message delivery system 280 performs forwarding table update function 340.

While particular fields are shown in a particular format in data structure 600, in practice, data structure 600 may include additional fields, fewer fields, different fields, or differently arranged fields than are shown in FIG. 6. Also, FIG. 6 illustrates examples of information stored by data structure 600. In practice, other examples of information stored by data structure 600 are possible.

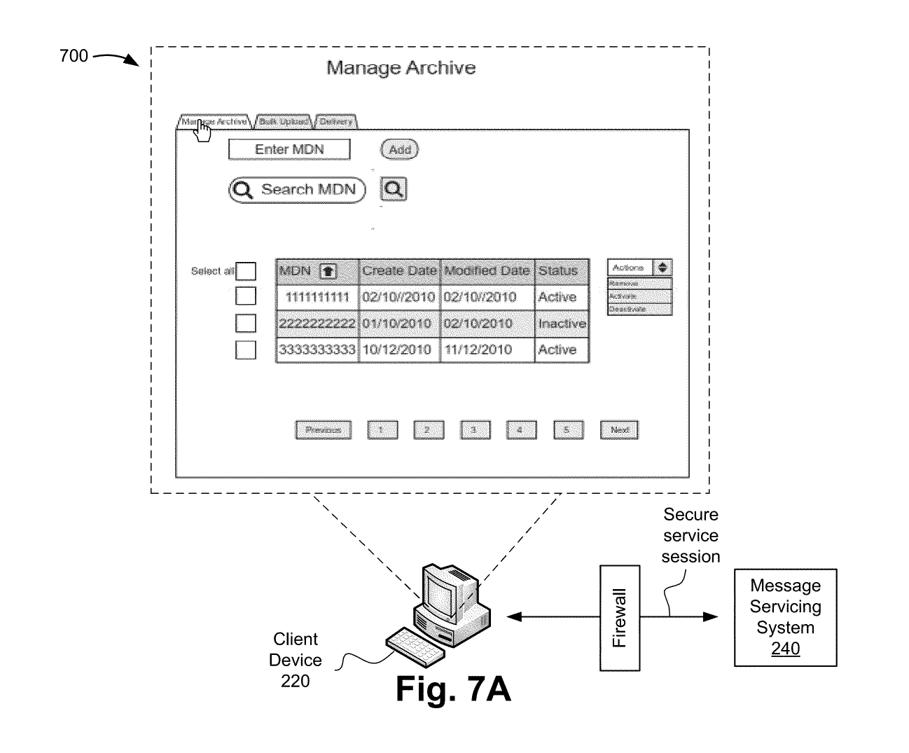

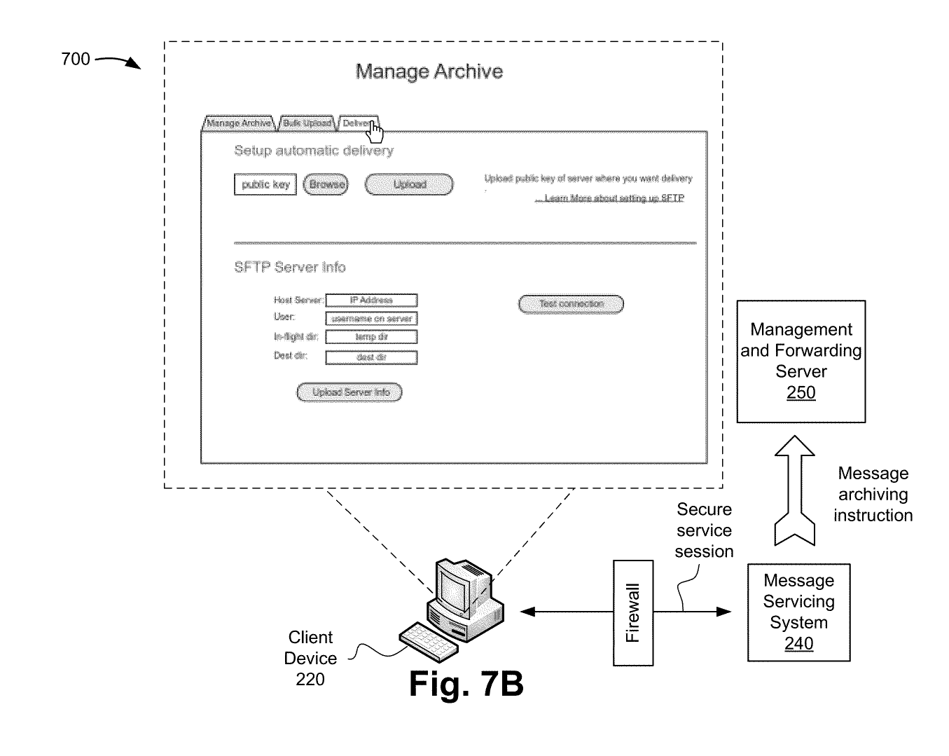

FIGS. 7A-7B illustrate an example implementation as described herein. As shown in FIG. 7A, client device 220 may communicate with message servicing system 240 via an established session to permit an administrator, associated with a group, to select message archiving instructions for one more user devices 210, identified by respective UDIDs, such as respective MDNs, associated with a particular group ID corresponding to the group. For example, client device 220 may provide message servicing system 240 with login credentials and/or some other information associated with the group ID. Based on receiving the login credentials, message servicing system 240 may authenticate the login credentials and establish a secure session (e.g., a session through a firewall). In some implementations, client device 220 may display (e.g., in interface 700) options for the administrator to add MDNs to an archive list, activate archiving services for MDNs in the archive list, deactivate archiving services for MDNs in the archive list, and/or remove MDNs from the archive list. In some implementations, a computer file including the list of MDNs may be uploaded such that manual entry of the MDNs may not be needed. For example, a computer file including a list of MDNs, associated with the group ID, may be maintained by an administrator of the group and used to upload the MDNs to the archive list. In some implementations, interface 700 may also present options to select message types that are to be archived for each MDN.

Referring to FIG. 7B, interface 700 may present options for the administrator to select delivery instructions of messages that are to be provided by management and forwarding server 250 and archived by client archiving server 230. In some implementations, interface 700 may present options to select a network address associated with client archiving server 230, and authorization information (e.g., a username, a password, a key, etc.) that management and forwarding server 250 may use to communicate with client archiving server 230 to provide client archiving server 230 with messages to be archived. As further shown in FIG. 7B, interface 700 may present an option to select a directory on client archiving server 230 where messages are to be stored on client archiving server 230. In some implementations, interface 700 may present options to test a connection with client archiving server 230. In some implementations, interface 700 may present options to direct management and forwarding server 250 to automatically provide messages to client archiving server 230 when messages are received by management and forwarding server 250 and/or to provide the messages in accordance with a delivery schedule.

In some implementations, selections of activation/deactivation instructions for MDNs and/or delivery instructions via interface 700 may correspond to a message archiving instruction provided to management and forwarding server 250. In some implementations, message servicing system 240 may receive the selections via message servicing system 240, generate the message archiving instruction based on the selections, and provide the message archiving instruction to management and forwarding server 250. Additionally, or alternatively, client device 220 may access management and forwarding server 250 via message servicing system 240 and may provide the selections to management and forwarding server 250. As described above, management and forwarding server 250 may instruction to activate or deactivate message archiving services for MDNs associated with the group ID without activating or deactivating message archiving services for MDNs not associated with the group ID.

While a particular example is shown in FIGS. 7A-7B, the above description is merely an example implementation. In practice, other examples are possible from what is described above in FIGS. 7A-7B. Also, while a particular format of interface 700 is shown, in practice, interface 700 may have a different format and appearance than what is shown in FIGS. 7A-7B.

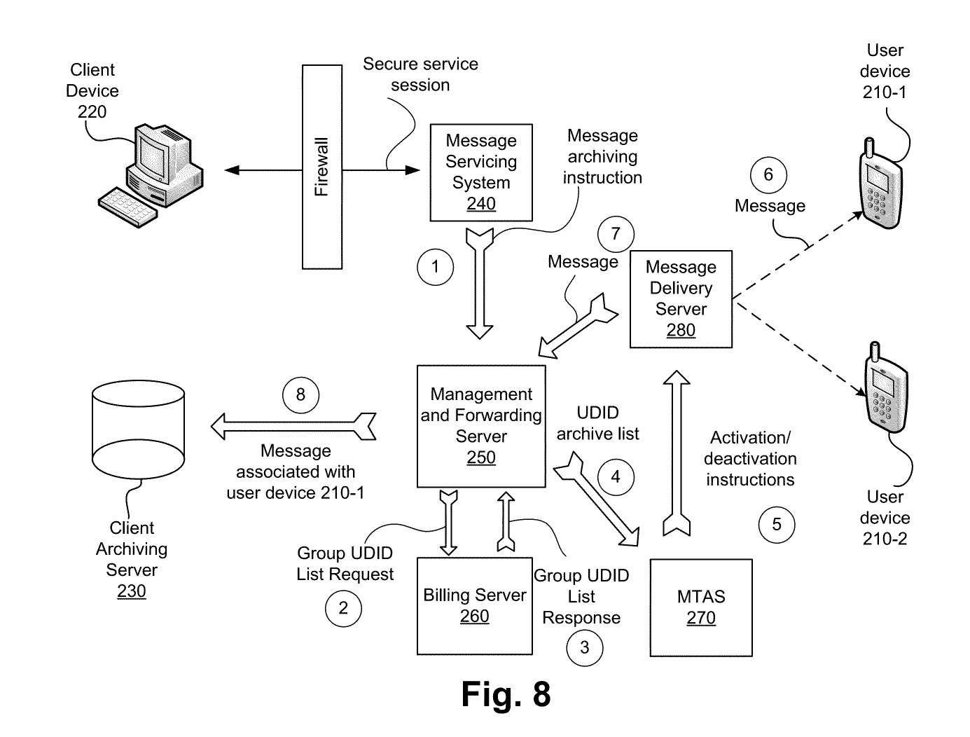

FIG. 8 illustrates an example implementation as described herein. As shown in (1) in FIG. 8, management and forwarding server 250 may receive a message archiving instruction including a group ID, instructions to activate and/or deactivate message archiving services for one or more UDIDs, types of messages that are to be archived, and/or delivery instructions (e.g., information identifying a particular client archiving server 230 and/or authorization credentials to communicate with client archiving server 230). Based on receiving the message archiving instruction, management and forwarding server 250 may provide a group UDID list request to billing server 260 (e.g., as shown in (2)) and receive a group UDID list response having a list of UDIDs that are associated with the group ID (e.g., as shown in (3)). Management and forwarding server 250 may generate a UDID archive list having a list of UDIDs associated with the group ID and UDIDs that are included in the message archiving instruction in addition to instructions to activate and/or deactivate message archiving services for the UDIDs. In some implementations, management and forwarding server 250 may further update a message forwarding table that identifies messages that are to be provided to client archiving server 230 for archiving.

As shown in (4), MTAS 270 may receive the UDID archive list and may update policy information and message processing instructions for message delivery system 280. As shown in (5), MTAS 270 may provide activation/deactivation instructions including instructions to activate and/or deactivate message forwarding to management and forwarding server 250. In some implementations, message delivery system 280 may update a forwarding table that identifies messages that are to be provided to management and forwarding server 250 (and subsequently provided to client archiving server 230 for archiving) based on the activation/deactivation instructions. In FIG. 8, assume that the activation/deactivation instructions identify that all types of messages associated with the UDID of user device 210-1 are to be provided to management and forwarding server 250. Given this assumption, and as shown in (6), message delivery system 280 may receive a message associated with the UDID of user device 210-1 and provide the message to management and forwarding server 250 when processing delivery of the message (e.g., as shown in (7)). In some implementations, management and forwarding server 250 may receive the message, identify that the message is to be provided to client archiving server 230 (e.g., based on the attributes of the message, such as the type of message, a UDID associated with the message, etc.), identify a particular client archiving server 230 that is to receive the message, and, as shown in (8), provide the message to client archiving server 230.

While a particular example is shown in FIG. 8, the above description is merely an example implementation. In practice, other examples are possible from what is described above in FIG. 8.

As described above, message archiving services for UDIDs associated with respective user devices 210 may be activated and/or deactivated based on determining that a message archiving instruction is received from an authorized party (e.g., when authorization credentials included in the message archiving instruction match authorization credentials stored by management and forwarding server 250). Further, the message archiving services for UDIDs may be activated and/or deactivated for those UDIDs associated with a group ID included in the message archiving instruction.

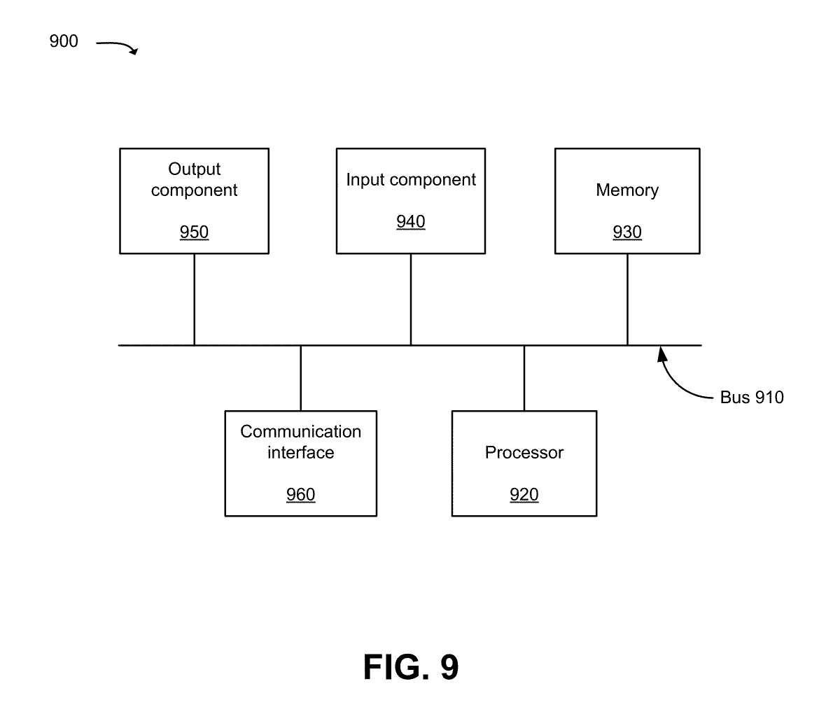

FIG. 9 is a diagram of example components of device 900. One or more of the devices described above (e.g., with respect to FIGS. 1-3, 7A-7B, and 9) may include one or more devices 900. Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, or processing logic that may interpret and execute instructions. Memory 930 may include any type of dynamic storage device that may store information and instructions for execution by processor 920, and/or any type of non-volatile storage device that may store information for use by processor 920.

Input component 940 may include a mechanism that permits an operator to input information to device 900, such as a keyboard, a keypad, a button, a switch, etc. Output component 950 may include a mechanism that outputs information to the operator, such as a display, a speaker, one or more light emitting diodes (“LEDs”), etc.

Communication interface 960 may include any transceiver-like mechanism that enables device 900 to communicate with other devices and/or systems. For example, communication interface 960 may include an Ethernet interface, an optical interface, a coaxial interface, or the like. Communication interface 960 may include a wireless communication device, such as an infrared (“IR”) receiver, a Bluetooth® radio (Bluetooth is a registered trademark of Bluetooth SIG, Inc.), radio, or the like. The wireless communication device may be coupled to an external device, such as a remote control, a wireless keyboard, a mobile telephone, etc. In some embodiments, device 900 may include more than one communication interface 960. For instance, device 900 may include an optical interface and an Ethernet interface.

Device 900 may perform certain operations relating to one or more processes described above. Device 900 may perform these operations in response to processor 920 executing software instructions stored in a computer-readable medium, such as memory 930. A computer-readable medium may be defined as a non-transitory memory device. A memory device may include space within a single physical memory device or spread across multiple physical memory devices. The software instructions may be read into memory 930 from another computer-readable medium or from another device. The software instructions stored in memory 930 may cause processor 920 to perform processes described herein. Alternatively, hardwired circuitry may be used in place of or in combination with software instructions to implement processes described herein. Thus, implementations described herein are not limited to any specific combination of hardware circuitry and software.

The foregoing description provides illustration and description, but is not intended to be exhaustive or to limit the possible implementations to the precise form disclosed. Modifications and variations are possible in light of the above disclosure or may be acquired from practice of the implementations.

It will be apparent that different examples of the description provided above may be implemented in many different forms of software, firmware, and hardware in the implementations illustrated in the figures. The actual software code or specialized control hardware used to implement these examples is not limiting of the implementations. Thus, the operation and behavior of these examples were described without reference to the specific software code—it being understood that software and control hardware can be designed to implement these examples based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A method comprising:
receiving, by a first device:
a group identifier, a first list including one or more first user device identifiers, and an instruction to archive messages associated with the one or more first user device identifiers;
receiving, by the first device, a second list including one or more second user device identifiers that are associated with the group identifier,
generating, by the first device, a third list based on the first list and the second list, the third list including one or more third user device identifiers that are in the first list and the second list,
receiving, by the first device, a message associated with a user device identifier;
determining, by the first device, that the message is to be archived when the user device identifier associated with the message is included in the third list; and
providing, by the first device, the message to a second device based on the determination that the message is to be archived.

2. The method of claim 1, wherein the determining that the message is to be archived is further based on one or more attributes of the message.

3. The method of claim 3, wherein the attributes of the message correspond to at least one of a message type, a telephone number, a mobile device number, an international mobile equipment identifier, or an integrated circuit card identifier.

4. The method of claim 1, further comprising:
receiving an instruction to discontinue archiving the messages associated with the one or more third user device identifiers.

5. The method of claim 1, wherein the second device is one of a plurality of second devices, and
wherein the instruction identifies a particular second device of the plurality of second devices.

6. The method of claim 5, wherein the instruction includes authorization information for the particular second device,
wherein providing the message to the second device includes providing the message using the authorization information to communicate with the particular second device.

7. The method of claim 1, wherein the second list is determined based on billing information that identifies user device identifiers associated with the group identifier.

8. The method of claim 1, further comprising:
providing a response identifying the first user device identifiers that are not included in the third list.

9. A system comprising:
a first server device configured to:
receive a group identifier, a first list including one or more first user device identifiers, and an instruction to archive messages associated with the one or more first user device identifiers;
receive a second list based on receiving the instruction,
the second list including one or more second user device identifiers that are associated with the group identifier,
generate a third list based on the first list and the second list,
the third list including one or more third user device identifiers that are in the first list and the second list,
receive a message associated with a user device identifier;
determine that the message is to be archived when the user device identifier associated with the message is included in the third list; and
provide the message to a second server device based on the determination that the message is to be archived.

10. The system of claim 9, wherein when determining that the message is to be archived, the first server device is further to determine that the message is to be archived based on one or more attributes of the message.

11. The system of claim 10, wherein the attributes of the message correspond to at least one of a message type, a telephone number, a mobile device number, an international mobile equipment identifier, or an integrated circuit card identifier.

12. The system of claim 9, wherein the first server device is further configured to:
receive an instruction to discontinue archiving the messages associated with the one or more third user device identifiers.

13. The system of claim 9, wherein the second server device is one of a plurality of second server devices, and
wherein the instruction identifies a particular second device of the plurality of second devices.

14. The system of claim 13, wherein the instruction includes authorization information for the particular second server device,
wherein when providing the message to the particular second server device, the first server device is further to provide the message using the authorization information to communicate with the particular second server device.

15. The system of claim 9, wherein the second list is determined based on billing information that identifies user device identifiers associated with the group identifier.

16. The system of claim 9, wherein the first server device is further to:
provide a response identifying the first user device identifiers that are not included in the third list.

17. A system comprising:
a first server device configured to:
store a forwarding table identifying messages that are to be provided to a second server device for archiving, by the second server device, based on one or more attributes of the messages;
receive a message;
determine that the message is to be provided to the second device based on one or more attributes of the message and information stored by the forwarding table; and
provide the message to the second server device based on determining that the message is to be provided to the second server device.

18. The system of claim 17, wherein the attributes of the message include at least one of a message type, a mobile device number, a telephone number, a user device identifier, an international mobile equipment identifier, or an integrated circuit card identifier.

19. The system of claim 17, wherein the second server device is one of a plurality of second devices,
wherein when storing the forwarding table, the first server device is further to store information identifying a particular second device of the plurality of second devices;
wherein when providing the message to the second server device, the first server device is further to provide the message to the particular second server device.

20. The system of claim 17, wherein when storing the forwarding table, the first server device is further to store information identifying authorization information for the second server device,
wherein when providing the message to the second server device, the first server device is further to provide the message using the authorization information to communicate with the second server device.
